(19) United States
(12) Patent Application Publication
(10) Pub. No.: US 2009/0019204 A1
(43) Pub. Date: Jan. 15, 2009

(54) SELF-HEALING NOISE DISPERSION SYSTEM FOR HIGH PERFORMANCE MULTIDROP SYSTEMS

(75) Inventors: Moises Cases, Austin, TX (US); Daniel N. de Araujo, Cedar Park, TX (US); Bhyrav M. Mutnury, Austin, TX (US); Nam H. Pham, Round Rock, TX (US)

Correspondence Address: HOFFMAN WARNICK LLC, 75 STATE STREET, 14TH FLOOR, ALBANY, NY, 12207, US

(73) Assignee: International Business Machines Corporation, Armonk, NY (US)

(21) Appl. No.: 11/777,307

(22) Filed: Jul. 13, 2007

(51) Int. Cl. G06F 13/14; G06F 13/16; G06F 13/20

(52) U.S. Cl. 710/301; 710/305; 710/308

(57) ABSTRACT

The key limiter in a multi-drop system, such as a multi-drop memory system, is the super-positioning of reflection noise from multiple modules or pluggable units, such as DIMMs. Using the noise cancellation approach of the present invention, the noise is distributed across the width of the pulse thus significantly reducing the impact of noise super-positioning. Use of the system of the present invention provides improved noise margins and is a key enabler of high performance, high speed bus, particularly at higher bit rates, as well as an enabler for higher capacity modules, such as DIMMs. The system provides for electrical traces from each of the modules of varying lengths thereby distributing the noise reflections.

### FIELD OF THE INVENTION

The present invention relates generally to noise dispersion and, more specifically, to a self-healing noise dispersion system for high performance multidrop systems.

### BACKGROUND OF THE INVENTION

Microprocessors, digital signal processors, digital imaging devices, and many other types of digital data processing devices rely on an attached high-speed memory system to hold data and/or processor instructions needed by the processing device. As these processing devices become faster and more powerful, the increased demands placed on them generally translate to a need for larger and faster attached memory systems.

One of the key limiters of high-speed multidrop interfaces, such as memory interfaces, is the reflection noise from capacitive loads on the bus. (More information on multidrop memory interfaces can be found here: http://ieeexplore.ieee.org/Xplore/login.jsp?url=/ie15/9408/29848/01362384.pdf). Other examples of high-speed buses in multi-drop systems are the front side bus (the front side bus (FSB) or system bus is the physical bi-directional data bus that carries all electronic signal information between an Intel® central processing unit (CPU) and I/O components), and the PCI-X bus (PCI-X (Peripheral Component Interconnect Extended) is a computer bus and expansion card standard designed to supersede PCI. It is essentially a faster version of PCI, running at twice the speed, and is otherwise similar in physical implementation and basic design.). At high speeds, multidrop interface shows great reduction in eye opening from reflections and inter symbol interference. A self-healing noise cancellation mechanism is needed to address the issue.

There presently is a need for a system for a self-healing noise dispersion system for high performance multi-drop systems.

### BRIEF SUMMARY OF THE INVENTION

The present invention is a self-healing noise dispersion system for high performance multi-drop systems.

In the multi-drop memory system example, the key limiter is the super-positioning of reflection noise from multiple DIMMs. In the other examples, it is the super-positioning of the units whether they are I/O controllers or add-on plug-in cards as examples. Using the noise cancellation approach of the present invention, the noise is distributed across the width of the pulse thus significantly reducing the impact of noise super-positioning. Use of the system of the present invention provides improved noise margins and is a key enabler of a high performance, high speed bus, such as memory bus, particularly at higher bit rates, as well as an enabler for higher capacity pluggable devices, such as DIMMs.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 depicts a typical Memory System Configuration.

FIG. 2 shows the modified memory System of the present invention incorporating self-healing noise cancellation mechanism.

FIG. 3 illustrates the operation of the noise cancellation system.

FIG. 4 illustrates the Eye Opening from typical multi-drop memory system running @800 Mbps.

FIG. 5 illustrates the Eye Opening from the Self Healing Noise Cancellation Mechanism of the present invention running @800 Mbps illustrating the 100 mV improvement.

The drawings are intended to depict only typical aspects of the invention, and therefore should not be considered as limiting the scope of the invention. In the drawings, like numbering represent like elements between the drawings.

### DETAILED DESCRIPTION OF THE PREFERRED EMBODIMENT OF THE PRESENT INVENTION

The present invention provides a system for a self-healing noise dispersion system for high performance multi-drop systems. For the remainder of the description of the present invention, a memory system will be used to describe the invention; however, it should be noted that the invention covers all high-performance multi-drop systems.

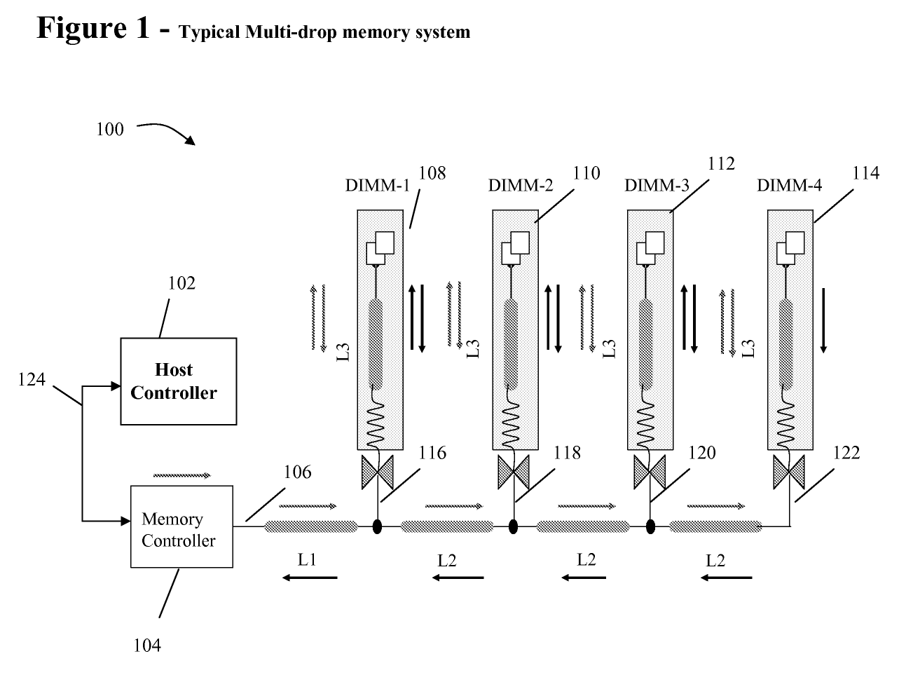

FIG. 1 depicts a typical Memory System Configuration 100. A Host Processor 102 issues data store and retrieve requests to a Memory Controller 104 over a Bus 124. Memory Controller 104 acts as an intermediary for the exchange of data between Processor 102 and Memory Units 108, 110, 112 and 114 over high-speed Data Bus 106.

In the configuration shown in FIG. 1, Data Bus 106 is a multi-drop memory bus. In other words, Bus 106 is arranged with a backbone of signal lines. A signal line stub, or “drop”, connects each of the memory devices to the backbone, e.g., Drops 116, 118, 120, and 122. Electrically, each stub or drop is a potential source of noise on Data Bus 106, as signal reflections from stubs connected to idle memory units can reach the intended recipient of a data transfer out-of-phase with the original signaling, increasing the probability that erroneous data will be sensed at the receiver.

Several terms have been assigned particular meanings within the context of this specification. A memory device is any device that contains addressable memory space that can be used to store and later retrieve digital data. A rank of memory devices is a collection of one or more devices addressable in parallel that, considered together, have a data path spanning the width of a data bus. A memory module is a removable memory unit carrying one or more ranks of memory devices. A memory unit can be a memory module, a rank of memory devices, or a single memory device, the unit being addressed together. A memory controller is a requesting device that has the capability to store/retrieve digital data to/from a memory unit using a bi-directional data bus. An address/command bus allows a memory controller to transmit requests to, e.g., read and write digital data to addressable locations in a memory unit's addressable memory space, the bus having the capability to serve more than one memory device or unit. A BIOS is a low-level operating system for a computer system, the BIOS generally defining the system hardware configuration and containing low-level software for initializing the computer system.

Although embodiments of the present invention can be embodied in a variety of systems, FIG. 1 is exemplary, and will thus be referenced herein. FIG. 1 shows a Memory System 100 including a Memory Controller 104. A multi-drop Data Bus 106 comprises a collection of Electrical Traces, such as L1, L2 and L3, routed on a printed circuit board known as the “main board” or “motherboard”. Memory Controller 104 mounts to the motherboard and connects to one end of the traces comprising Data Bus 106. Each drop of Data Bus 106 connects to an electrical terminator, or socket. A typical main board contains multiple memory sockets.

Memory is added to the memory system by inserting Memory Modules (e.g., 108, 110, 112, 114) into one or more of the sockets. One popular type of memory module is a Dual In-line Memory Module, or DIMM. The DIMM is a rectangular low-profile circuit board that has electrical contact points arranged on both sides along one long edge. The contact points form electrical connections to the main board's memory bus when the DIMM is inserted into a DIMM memory socket.

A DIMM generally has multiple individual memory devices mounted to it. The devices can all work in parallel to perform memory functions. For instance, a DIMM may have a rank of eight memory devices, each of which receives the same memory address from the controller. If the width of the data bus is 32 bits, each of the eight memory devices is responsible for four bits of the data word that is placed on the memory bus.

FIG. 1 shows a typical Memory System implementation 100 that illustrates the problem of noise reflection. Memory units 108, 110, 112 114 connect with Memory Controller 104 conventionally using the Address/Command Bus 106. It can be seen that during a write or read operation between Memory Controller and DIMM-4, the reflection noise from DIMMs 1, 2 and 3 get super-positioned. For instance, there is a memory read from DIMM-4 (DIMM-4 to Memory Controller)—L3+3*L2+L1. The reflection from DIMM-3 is 3*L3+3*L2+L1. The reflection from DIMM-2 is 3*L3+3*L2+L1 and the reflection from DIMM-1 is 3*L3+3*L2+L1. In other words, the three reflections occur at the same time causing a higher voltage drop due to the reflections occurring simultaneously at DIMM-4.

The present invention utilizes this novel approach using a noise cancellation mechanism where the super-positioning of noise from various DIMMs is distributed across the width of the bit period.

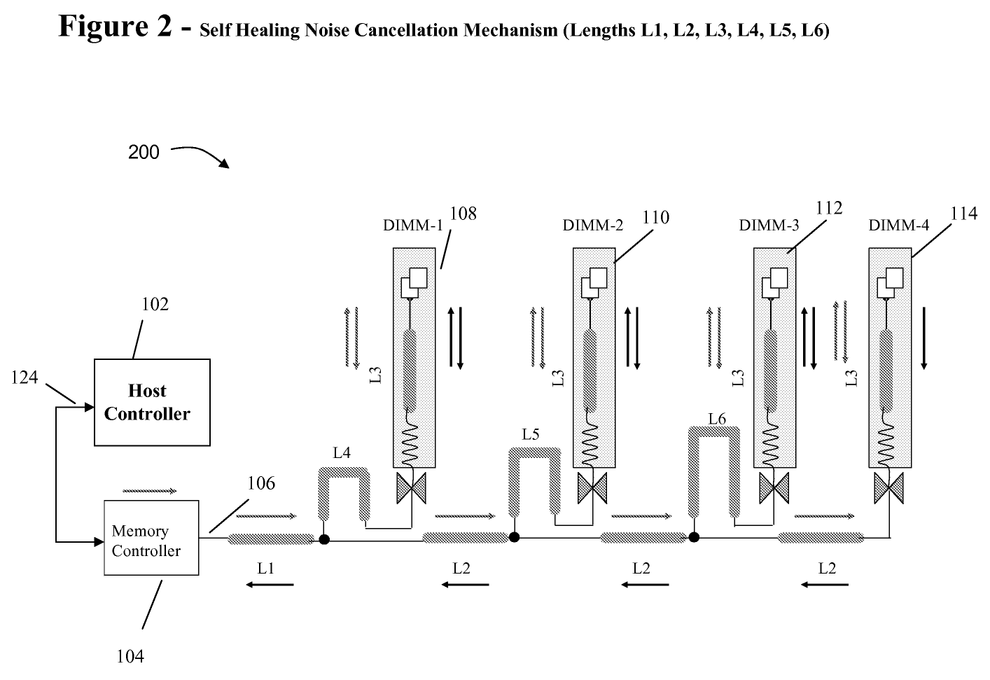

FIG. 2 shows the modified memory System 200 of the present invention incorporating self-healing noise cancellation mechanism. L1, L2, L3, L4, L5, and L6 are the physical lengths. There is a read from DIMM-4 (DIMM-4 to Memory Controller)—L3+3*L2+L1. The reflection from DIMM-3 is 3*L3+2*L6+3*L2+L1. The reflection from DIMM-2 is 3*L3+2*L5+3*L2+L1. The reflection from DIMM-1 is 3*L3+2*L4+3*L2+L1. L1, L2, L3, L4, L5, and L6 are the physical lengths. Because the reflections at DIMM-4 from DIMM-1, DIMM-2 and DIMM-3 do not occur simultaneously due to the varying lengths of Electrical Traces L4, L5 and L6, the voltage drops are distributed.

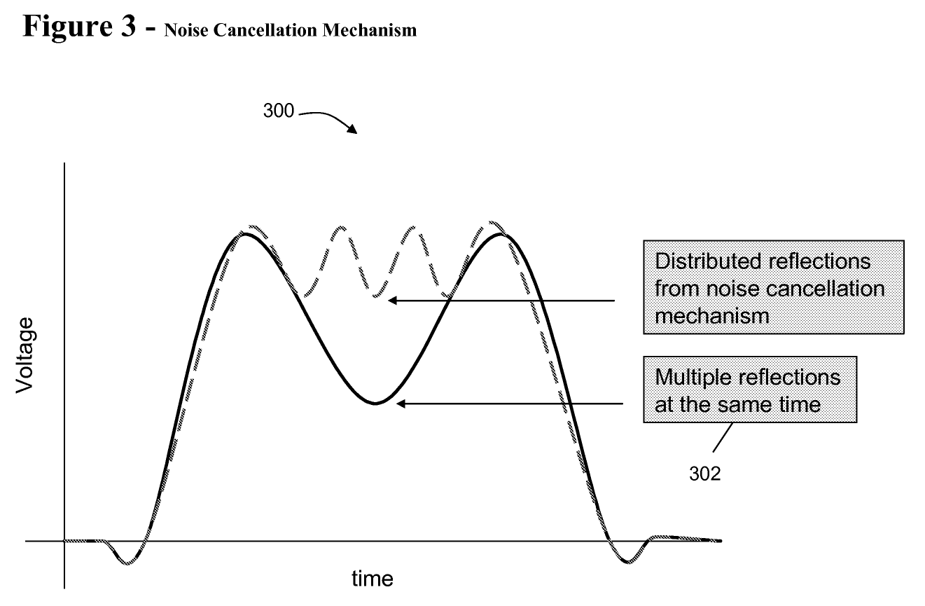

The operation of the noise cancellation system 300 is shown in FIG. 3. Without the noise cancellation system of the present invention, at 302, multiple reflections (as shown in FIG. 1) can occur at the same time causing a dramatic drop in voltage. Using the noise cancellation system of the present invention (as shown in FIG. 2), the reflections are distributed so that there is not a dramatic drop in voltage.

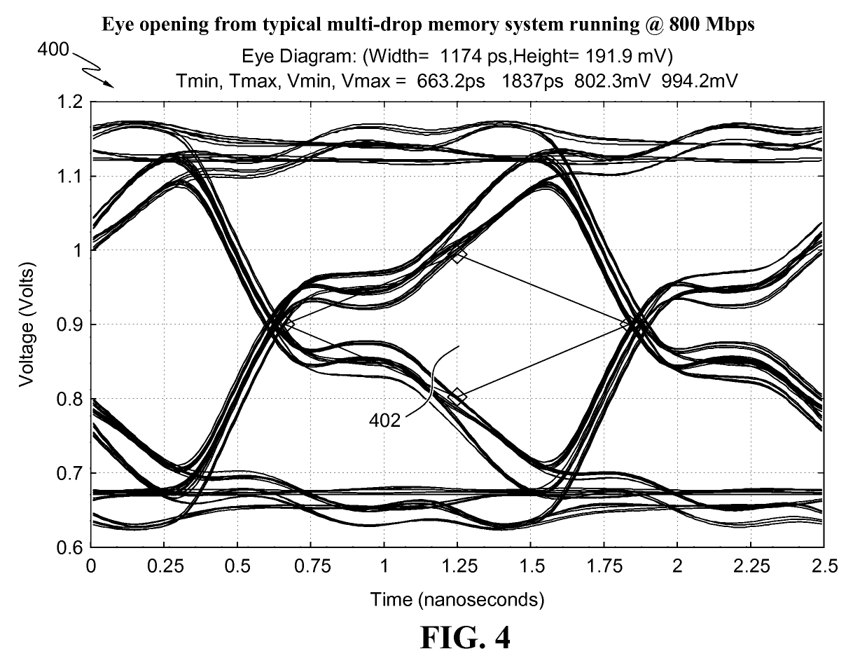

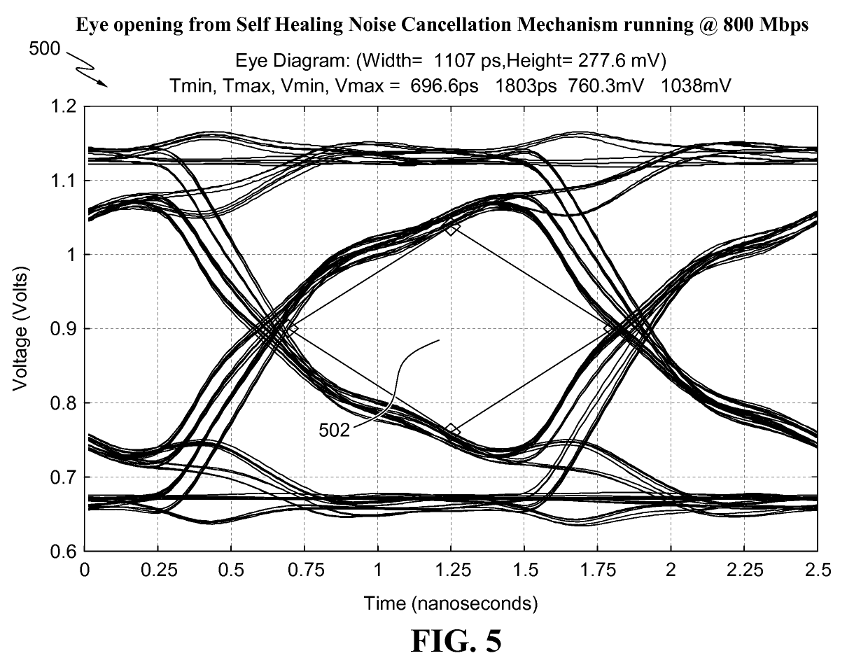

It can also be seen in FIGS. 4 and 5 which illustrate that there is a 100 mV improvement using the self-healing noise cancellation mechanism compared to today's multi-drop memory system @800 Mbps read operation. FIG. 4 illustrates the Eye Opening 402 from typical multi-drop memory system running @800 Mbps while FIG. 5 illustrates the Eye Opening 502 from the Self Healing Noise Cancellation Mechanism of the present invention running @800 Mbps illustrating the 100 mV improvement.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A self-healing noise dispersion system for high performance multidrop systems comprising:
a. a multidrop data bus having a number of electrical traces;
b. a controller to transmit command signals on the multidrop data bus, and to transmit and receive data signals on the multidrop data bus corresponding to the address and command signals; and
c. at least three units, each connected to the multidrop data bus, the at least three units being connected by electrical traces of different lengths.

2. The system of claim 1 further including a host controller.

3. The system of claim 1 wherein the multidrop data bus is a memory bus, the controller is a memory controller and the units are memory units.

4. The system of claim 3 wherein the memory units are dual in-line memory modules (DIMMs).

5. The system of claim 3 wherein the controller issues a read command to one of the at least three memory units, the read command causing noise reflections from the other memory units, and the electrical traces of different lengths causing those noise reflections to be dispersed.

6. The system of claim 5 wherein the noise reflections are distributed across the width of a pulse thus significantly reducing the impact of noise super-positioning.

7. The system of claim 5 wherein the self-healing noise dispersion system provides improved noise margins and is a key enabler of high performance, high speed memory bus, particularly at higher bit rates, as well as an enabler for higher capacity dual in-line memory modules (DIMMs).

8. The system of claim 1 wherein the units are super positioned.

9. The system of claim 1 wherein the multidrop bus is high-speed and the units provide capacitive loads on the bus causing reflection noise.

10. The system of claim 9 wherein the eye opening is increased at high speeds.

11. The system of claim 1 wherein the multidrop data bus is an I/O bus, the controller is an I/O controller and the units are I/O controllers.

12. The system of claim 1 wherein the multidrop data bus is a peripheral component interconnect bus, the controller is a peripheral component controller and the units are add-on plug-in cards.
